(19) United States
(12) Patent Application Publication
(10) Pub. No.: US 2018/0374100 A1
(43) Pub. Date: Dec. 27, 2018

(54) SETTLEMENT METHOD, ENTRANCE CONTROL METHOD, AND APPARATUS

(71) Applicant: Alibaba Group Holding Limited, George Town (KY)

(72) Inventors: Le Zhou, Hangzhou (CN); Xiaodong Zeng, Hangzhou (CN); Li Chen, Hangzhou (CN); Hong Zhang, Hangzhou (CN); Xiaobo Zhang, Hangzhou (CN); Sihai Yao, Hangzhou (CN)

(73) Assignee: Alibaba Group Holding Limited, George Town (KY)

(21) Appl. No.: 16/014,917

(22) Filed: Jun. 21, 2018

(30) Foreign Application Priority Data
Jun. 23, 2017 (CN) 201710490952.X

(51) Int. Cl. G06Q 20/40; G06K 7/10; G06Q 20/12

(52) U.S. Cl. CPC G06Q 20/40145; G06K 2017/0067; G06Q 20/12; G06K 7/10297

(57) ABSTRACT

A computer-implemented method comprises: obtaining, by the settlement device, a biometric feature of the user; determining, by the settlement device, that the obtained biometric feature matches a stored biometric feature, wherein the stored biometric feature corresponds to an account identifier; and in response to determining that the obtained biometric feature matches the stored biometric feature, performing, by the settlement device, a settlement of an account associated with the account identifier that corresponds to the stored biometric feature.

This application claims priority to Chinese Patent Application No. 201710490952.X, filed on Jun. 23, 2017, which is hereby incorporated by reference in its entirety.

### TECHNICAL FIELD

The present application relates to the field of information technologies, and in particular, to a settlement method, an entrance control method, and an apparatus.

### BACKGROUND

Currently, during settlement of offline shopping (such as supermarket shopping), a user needs to deliver a purchased product to a checkout counter for settlement. After the checkout counter determines an amount the user needs to pay, the user can leave with the purchased product only after paying for it by operating a mobile phone or using a bank card.

For example, it is inconvenient for a user who carries a product to perform the operations involving operating a mobile phone to start a payment application, finding a two-dimensional code, and presenting the two-dimensional code to a checkout counter. After the checkout counter scans the two-dimensional code, the user further needs to enter a payment password on the mobile phone.

### SUMMARY

Embodiments of the present application provide a settlement method, an entrance control method, and an apparatus, so as to resolve a problem that a user shops with low convenience in an existing settlement method.

To resolve the described technical problem, the embodiments of the present application are implemented as follows.

An embodiment of the present application provides a settlement method, including: obtaining, by an entrance device, a first biometric feature and an account identifier of a user; establishing, by the entrance device, a correspondence between the first biometric feature and the account identifier, and storing the first biometric feature, the account identifier, and the correspondence in a storage device; collecting, by a settlement device, a second biometric feature of the user; determining, by the settlement device, the account identifier that is stored in the storage device and that corresponds to the first biometric feature that matches the second biometric feature; and performing, by the settlement device, settlement by using the determined account identifier.

An embodiment of the present application provides an entrance control method, including: obtaining, by an entrance device, a first biometric feature and an account identifier of a user; establishing a correspondence between the first biometric feature and the account identifier; and controlling an entrance to be open.

An embodiment of the present application provides another settlement method, including: collecting, by a settlement device, a second biometric feature of a user; determining, based on a pre-stored first biometric feature, a pre-stored account identifier, and a pre-stored correspondence between the first biometric feature and the account identifier, the account identifier corresponding to the first biometric feature that matches the second biometric feature; and performing settlement by using the determined account identifier.

An embodiment of the present application provides a management system, including an entrance device, a storage device, and a settlement device.

The entrance device obtains a first biometric feature and an account identifier of a user, establishes a correspondence between the first biometric feature and the account identifier, and sends the first biometric feature, the account identifier, and the correspondence to the storage device.

The storage device receives and stores the first biometric feature, the account identifier, and the correspondence.

The settlement device collects a second biometric feature of the user and determines the account identifier corresponding to the first biometric feature that matches the second biometric feature based on the first biometric feature, the account identifier, and the correspondence that are stored in the storage device. Also, the settlement device performs settlement by using the determined account identifier.

An embodiment of the present application provides a settlement apparatus, including: an acquisition module, configured to obtain a first biometric feature and an account identifier of a user; a processing module, configured to: establish a correspondence between the first biometric feature and the account identifier, and store the first biometric feature, the account identifier, and the correspondence in a storage device; a collection module, configured to collect a second biometric feature of the user; a determining module, configured to determine the account identifier that is stored in the storage device and that corresponds to the first biometric feature that matches the second biometric feature; and a settlement module, configured to perform settlement by using the determined account identifier.

An embodiment of the present application provides an entrance control apparatus, including: an acquisition module, configured to obtain a first biometric feature and an account identifier of a user; a processing module, configured to establish a correspondence between the first biometric feature and the account identifier; and a control module, configured to control an entrance to be open.

An embodiment of the present application provides another settlement apparatus, including: a collection module, configured to collect a second biometric feature of a user; a determining module, configured to determine, based on a pre-stored first biometric feature, a pre-stored account identifier, and a pre-stored correspondence between the first biometric feature and the account identifier, the account identifier corresponding to the first biometric feature that matches the second biometric feature; and a settlement module, configured to perform settlement by using the determined account identifier.

An embodiment of the present application provides a settlement device, including one or more processors and a memory. The memory stores a program, and the program is configured to be used by the one or more processors to perform the following steps: obtaining a first biometric feature and an account identifier of a user; establishing a correspondence between the first biometric feature and the account identifier; collecting a second biometric feature of the user; determining the account identifier corresponding to the first biometric feature that matches the second biometric feature; and performing settlement by using the determined account identifier.

An embodiment of the present application provides an entrance control device, including one or more processors and a memory. The memory stores a program, and the program is configured to be used by the one or more processors to perform the following steps: obtaining, by an entrance device, a first biometric feature and an account identifier of a user; establishing a correspondence between the first biometric feature and the account identifier; and controlling an entrance to be open.

An embodiment of the present application provides a settlement device, including one or more processors and a memory. The memory stores a program, and the program is configured to be used by the one or more processors to perform the following steps: collecting, by the settlement device, a second biometric feature of a user; determining, based on a pre-stored first biometric feature, a pre-stored account identifier, and a pre-stored correspondence between the first biometric feature and the account identifier, the account identifier corresponding to the first biometric feature that matches the second biometric feature; and performing settlement by using the determined account identifier.

It can be seen from the technical solutions provided in the embodiments of the present application that when the user enters a store, the biometric feature and the account identifier of the user are obtained, and the correspondence between the biometric feature and the account identifier of the user is established. When the user pays, the biometric feature of the user is collected again to determine the account identifier of a settlement account. As such, the user does not need to operate a mobile phone or use a bank card for payment. Instead, a system automatically performs settlement by using the account corresponding to the determined account identifier, and therefore, the user can shop more conveniently.

### BRIEF DESCRIPTION OF DRAWINGS

To describe the technical solutions in the embodiments of the present application or in the existing technology more clearly, the following briefly describes the accompanying drawings used for describing the embodiments. Apparently, the accompanying drawings in the following description merely show some embodiments of the present application, and a person of ordinary skill in the art can still derive other drawings from these accompanying drawings without creative efforts.

FIG. 1 is a flowchart illustrating a settlement method according to an embodiment of the present application;

FIG. 2 is a schematic diagram illustrating a settlement system according to an embodiment of the present application;

FIG. 3 is a schematic diagram of entering a cafe by a user according to an embodiment of the present application;

FIG. 4 is a schematic diagram of paying by a user in a cafe according to an embodiment of the present application;

FIG. 5 is a schematic diagram illustrating an entrance control apparatus according to an embodiment of the present application;

FIG. 6 is a schematic diagram illustrating a settlement apparatus according to an embodiment of the present application;

FIG. 7 is a schematic diagram illustrating another settlement apparatus according to an embodiment of the present application;

FIG. 8 is a schematic diagram illustrating a settlement device according to an embodiment of the present application;

FIG. 9 is a schematic diagram illustrating an entrance control device according to an embodiment of the present application;

FIG. 10 is a schematic diagram illustrating another settlement device according to an embodiment of the present application; and

FIG. 11 is a flowchart illustrating an example of a computer-implemented method 1100 for performing a settlement, according to an implementation of the present disclosure.

### DESCRIPTION OF EMBODIMENTS

Application scenarios in embodiments of the present application can be offline shopping (such as supermarket shopping), an offline service (such as an Internet bar service or a fitness service), etc. Settlement happens in these application scenarios. Users sometimes need to operate a mobile phone or use a bank card for payment while users sometimes need to punch in, pay on account, etc. In conclusion, it is less convenient for users to shop or be served in an existing settlement process. For ease of description, the following uses the offline shopping scenario as an example for description.

For a person skilled in the art to understand the technical solutions in the present application better, the following clearly and completely describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present application.

The following describes in detail the technical solutions provided in the embodiments of the present application with reference to the accompanying drawings.

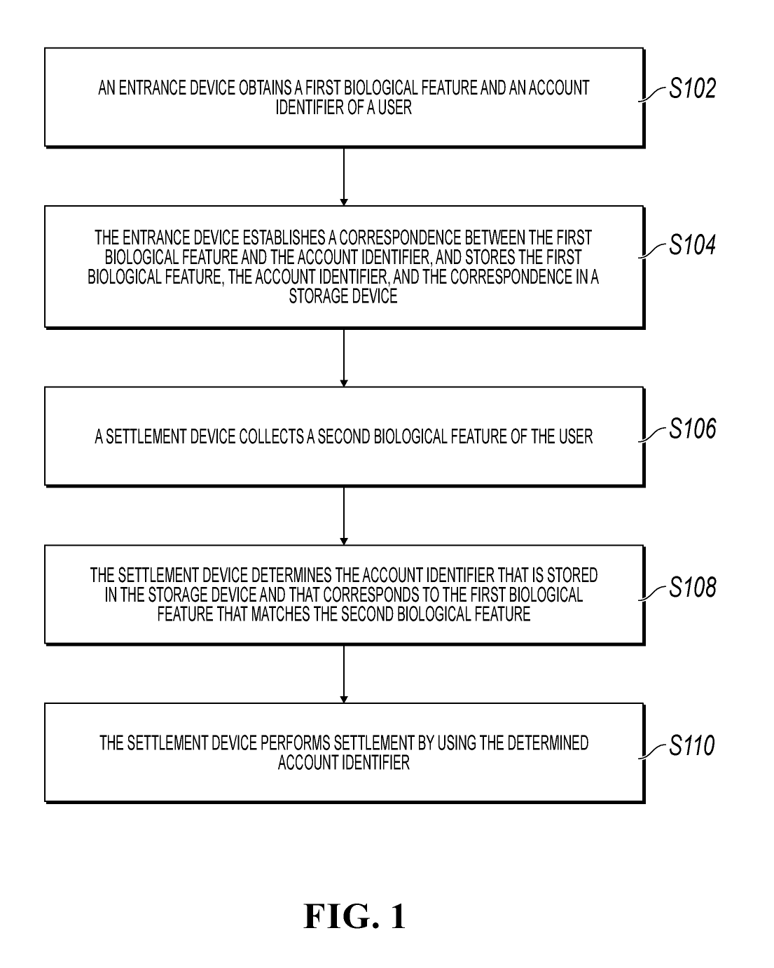

FIG. 1 is a flowchart illustrating a settlement method according to an embodiment of the present application, and the method includes the following steps.

S102. An entrance device obtains a first biometric feature and an account identifier of a user.

The method is executed by the entrance device and a settlement device. In an offline shopping scenario, the entrance device can be deployed at an entrance of a store, and the settlement device can be deployed at an exit of the store.

In this embodiment of the present application, there are two processes: an entry process and a settlement process. Steps S102 to S104 correspond to the entry process and are performed by the entrance device, and steps S106 to S110 correspond to the settlement process and are performed by the settlement device. A same user first enters a store, purchases a product, and then pays for it.

In the entry process, the entrance device can obtain the first biometric feature and the account identifier of the user. The account identifier of the user is actually provided by the user to the entrance device in the entry process. The first biometric feature is a biometric feature of the user that is collected by the entrance device in the entry process, and can uniquely identify an identity of the user. In this embodiment of the present application, a type of the biometric feature can be facial features, fingerprint, voice, eye, iris, etc.

In this embodiment of the present application, the first biometric feature, a second biometric feature, and a third biometric feature are used to distinguish between multiple biometric features of a same user that are collected for multiple times. The second biometric feature and the third biometric feature described below each have a same type as the first biometric feature. For example, the first biometric feature, the second biometric feature, and the third biometric feature can all be facial features.

In the entry process, the entrance device can collect a facial feature of the user by using a camera. In addition, the entrance device can receive the account identifier that is sent after the user scans a two-dimension code at the entrance by using a terminal.

For example, a user who wants to enter a store can operate a terminal, start an application, and scan a two-dimensional code posted or displayed at an entrance of the store, to obtain a communication address of the entrance device that is included in the two-dimensional code, and then the terminal sends an account identifier to the communication address.

Certainly, in the entry process, the first biometric feature of the user may not need to be collected on site, but is obtained in another way. This is not specifically limited in the present application. The user may not need to scan the two-dimensional code, but instead, the entrance device sends a request to the terminal of the user, and the terminal returns the account identifier in response to the request. As such, the user does not need to perform additional operations in the entry process.

In conclusion, a specific acquisition method is not limited in the present application provided that the entrance device can obtain the first biometric feature and the account identifier of the user in the entry process.

S104. The entrance device establishes a correspondence between the first biometric feature and the account identifier, and stores the first biometric feature, the account identifier, and the correspondence in a storage device.

In the entry process, the entrance device can directly establish the correspondence between the obtained first biometric feature and the obtained account identifier of the user. In this case, the entrance device actually considers by default that the obtained account identifier is an account identifier of the user.

However, a user may enter a store by using an account identifier of another user. For example, Alice enters a store by using a mobile phone stolen from Bob, and the entrance device collects a biometric feature of Alice and receives an account identifier provided by Alice by operating the mobile phone. In this case, actually a correspondence between the biometric feature of Alice and the account identifier of Bob is subsequently established. Therefore, an account of a person can be stolen and used by others.

Furthermore, the entrance device can further establish the correspondence between the first biometric feature and the account identifier only after determining that the first biometric feature is valid. If the first biometric feature is invalid, the entrance device does not establish the correspondence between the first biometric feature and the account identifier, and therefore, the user cannot pay by using the account identifier although the user has been in the store.

Whether the first biometric feature is valid depends on whether the first biometric feature matches a biometric feature of an owner of the account identifier, and the two biometric features correspond to a same user if the two biometric features match each other (for example, a matching degree is greater than a specific threshold).

Specifically, the entrance device can search for, based on the account identifier, a third biometric feature associated with the account identifier. If the first biometric feature matches the third biometric feature, the entrance device determines that the first biometric feature is valid. If the first biometric feature does not match the third biometric feature, the entrance device determines that the first biometric feature is invalid. The third biometric feature associated with the account identifier is a biometric feature uploaded by the owner of the account identifier when the owner registers an account, or a biometric feature that is registered for the account during real-name authentication. That is, the third biometric feature is a biometric feature collected for the owner of the account identifier and therefore is reliable.

The entrance device can search for the third biometric feature by using a reliable third-party server. Specifically, the entrance device can search for, based on the account identifier by using a server (for example, a payment platform) that manages an account corresponding to the account identifier, the third biometric feature associated with the account identifier. After a user registers an account on the server, and obtains an account identifier allocated by the server, the server usually further requires the user to upload an identity card and a collected biometric feature of the user, so as to complete real-name authentication on the user. Therefore, the third biometric feature found by the server that manages the account corresponding to the account identifier is a biometric feature of the owner of the account identifier.

If the user has not been authenticated by using a real name on the server that manages the account corresponding to the account identifier, the entrance device can obtain the biometric feature of the owner of the account identifier from servers of authority organizations such as the public security agencies and the banks. Apparently, the servers of these authority organizations store a correspondence between an account identifier and a biometric feature of an owner of the account identifier.

In this embodiment of the present application, the storage device can be independent of the entrance device and the settlement device, and is configured to store data. In addition, the storage device can be the same as the entrance device, or can be a memory in the entrance device.

After establishing the correspondence between the first biometric feature and the account identifier, the entrance device can control the entrance to be open, so that the user can enter the store.

S106. A settlement device collects a second biometric feature of the user.

In this embodiment of the present application, the second biometric feature is a biometric feature of the user that is collected by the settlement device in the settlement process.

S108. The settlement device determines the account identifier that is stored in the storage device and that corresponds to the first biometric feature that matches the second biometric feature.

S110. The settlement device performs settlement by using the determined account identifier.

The entrance device has obtained the first biometric feature and the user identifier of the user and established the correspondence between the first biometric feature and the user identifier of the user in the previous entry process. Therefore, in the settlement process, the settlement device can first determine, based on the collected second biometric feature of the user, the first biometric feature that matches the second biometric feature in the storage device, which contains the first biometric features.

As described above, two biometric features that match each other correspond to a same user. Therefore, the settlement device can subsequently determine the account identifier corresponding to the first biometric feature that matches the second biometric feature, and the account corresponding to the determined account identifier is a settlement account. The settlement device can perform settlement by using the settlement account. As such, the user does not need to use a mobile phone or a bank card to pay in the settlement process.

In the offline shopping scenario, the settlement device can further identify a product carried by the user and perform settlement on the product carried by the user by using the account corresponding to the determined account identifier.

A radio frequency identification (RFID) technology can be used. A product in the store includes an RFID tag, and the settlement device includes an RFID reader. The RFID reader can read product information in an RFID tag in a settlement area. The product information includes a product price, and the RFID tag in the settlement area is an RFID tag attached to the product carried by the user in the settlement area. Then the settlement device calculates a settlement amount corresponding to the product carried by the user based on the product price included in the read product information and performs settlement based on the settlement amount by using the account corresponding to the determined account identifier.

Certainly, the to-be-settled product carried by the user can be identified in more other ways. For example, the settlement device can pre-store image information and weight information of each product, and a camera and a gravity sensor are installed on a cart. The camera is configured to collect image information of a product in the cart, and the gravity sensor is configured to collect weight information of the product in the cart.

In the settlement process, the settlement device collects the image information and the weight information of the product in the cart by using the camera and the gravity sensor that are installed on the cart in the settlement area, then determines, based on the collected image information and the collected weight information, the product corresponding to the collected image information and the collected weight information, and uses the product as the product carried by the user.

In conclusion, various identification technologies are used to automatically identify a product carried by a user. Therefore, the product does not need to be checked manually, so that settlement is more efficient, and the user can shop more conveniently.

According to the settlement method shown in FIG. 1, when the user enters the store, the biometric feature and the account identifier of the user are obtained, and the correspondence between the biometric feature and the account identifier of the user is established. When the user pays, the biometric feature of the user is collected again to determine the account identifier of the settlement account. As such, the user does not need to operate the mobile phone or use the bank card for payment. Instead, a system automatically performs settlement by using the account corresponding to the determined account identifier, and therefore, the user can shop more conveniently.

In addition, before step S104, when determining that the first biometric feature is valid, the entrance device can allow the user to enter the store by controlling an access control device disposed at the entrance of the store. When determining that the first biometric feature is invalid, the entrance device rejects entry of the user to the store by controlling an access control device disposed at the entrance of the store. As such, a user who uses an account identifier of another person is prevented from entering the store.

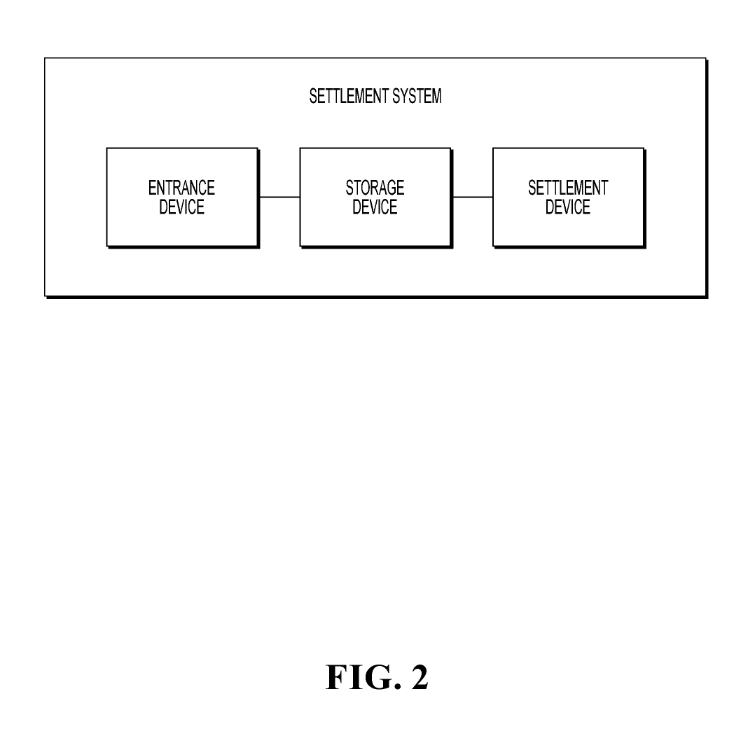

FIG. 2 shows a settlement system according to an embodiment of the present application. The settlement system includes an entrance device, a storage device, and a settlement device.

The entrance device obtains a first biometric feature and an account identifier of a user, establishes a correspondence between the first biometric feature and the account identifier, and sends the first biometric feature, the account identifier, and the correspondence to the storage device.

The storage device receives and stores the first biometric feature, the account identifier, and the correspondence.

The settlement device collects a second biometric feature of the user and determines the account identifier corresponding to the first biometric feature that matches the second biometric feature based on the first biometric feature, the account identifier, and the correspondence that are stored in the storage device. Also, the settlement device performs settlement by using the determined account identifier.

Further, the entrance device includes a camera, and the camera is configured to collect the first biometric feature (such as a facial feature) of the user. The settlement device includes a camera, and the camera is configured to collect the second biometric feature (such as a facial feature) of the user.

Further, a product includes an RFID tag, and the settlement device includes an RFID reader and a processor. The RFID reader is configured to read product information, which includes the product price, in an RFID tag in a settlement area. The RFID tag in the settlement area is an RFID tag attached to a product carried by the user in the settlement area. The processor calculates a settlement amount corresponding to the product carried by the user based on the product price included in the read product information and performs settlement based on the settlement amount by using an account corresponding to the determined account identifier.

For details of the settlement system shown in FIG. 2, refer to the description of the settlement method shown in FIG. 1.

The following further describes the system shown in FIG. 2 by using an example that a user enters a cafe to purchase coffee.

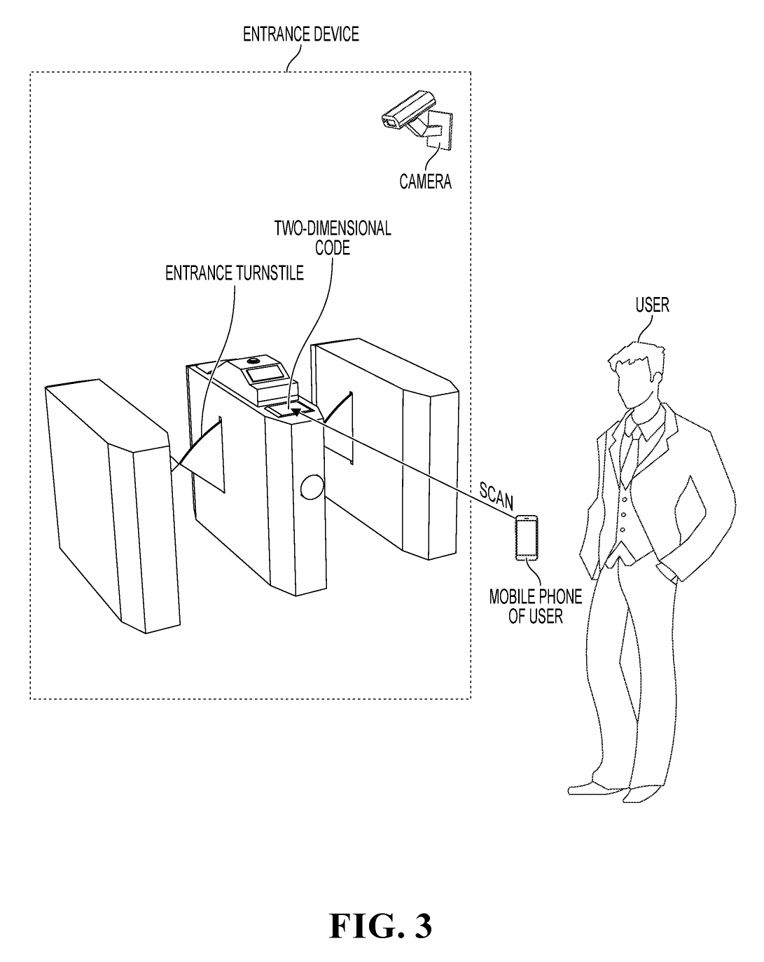

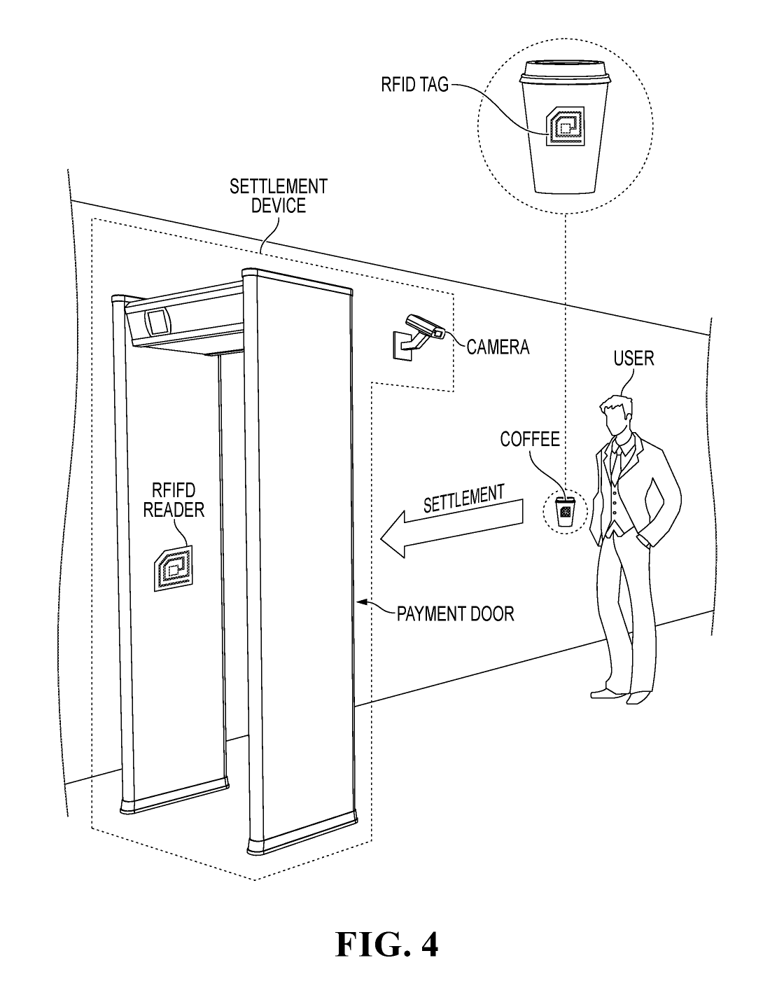

FIG. 3 is a schematic diagram of entering a cafe by a user according to an embodiment of the present application. FIG. 4 is a schematic diagram of paying by a user in a cafe according to an embodiment of the present application.

As shown in FIG. 3, an entrance device is deployed at an entrance of the cafe, the entrance device includes at least a camera, an entrance turnstile, and an entrance controller (which can be integrated into the entrance turnstile and is not shown in the figure). In addition, a two-dimensional code is posted on the entrance turnstile. The camera is configured to collect a first facial feature (a first biometric feature) of a user entering the store, and the entrance turnstile is configured to control the number of people at the entrance. The entrance controller is configured to control the camera and the entrance turnstile and obtain a facial feature and an account identifier of the user and perform subsequent processing. The two-dimensional code includes a communication address of the entrance controller. After the user scans the two-dimensional code by using a mobile phone, the entrance controller receives the account identifier.

It should be noted that the entrance controller can be used for storage and can be configured to store the first facial feature, the account identifier, and a correspondence between the first facial feature and the account identifier.

Specifically, the user who wants to enter the store scans the two-dimensional code by using the mobile phone, so as to send the user identifier to the entrance controller. After receiving the account identifier, the entrance controller controls the camera to collect the first facial feature of the user. Certainly, a human body sensor can also be integrated into the entrance turnstile. When detecting that a user gets close, the human body sensor triggers the entrance controller. The entrance controller controls the camera to collect the first facial feature of the user, and obtains the account identifier. After obtaining the facial feature and the account identifier of the user, the entrance controller determines whether the first facial feature is valid (that is, whether an owner of the account identifier is to enter the store). If the first facial feature is valid, the entrance controller establishes the correspondence between the first facial feature and the account identifier, and controls the entrance turnstile to be open so that the user can enter the store. If the first facial feature is invalid, the entrance controller does not control the entrance turnstile to be open and reminds the user that only the owner of the account identifier can enter the store.

As shown in FIG. 4, a settlement device is deployed at the entrance of the cafe, and the settlement device includes at least a camera, a payment door, and a settlement controller (which can be integrated into the payment door and is not shown in the figure). The camera is configured to collect a second biometric feature (second biometric feature) of the user who pays, and the payment door, which is a settlement area, includes an RFID reader that can identify an RFID tag on a coffee cup. The settlement controller is configured to control the camera and the payment door; and determine an account identifier used for settlement and charge the user.

It should be noted that the settlement controller in the settlement device shown in FIG. 4 can interact with the entrance controller shown in FIG. 3, so as to determine the account identifier used for settlement based on the first facial feature, the account identifier, and the correspondence between the first facial feature and the account identifier that are stored in the entrance controller.

Specifically, when the user enters the payment door or gets close to the payment door, the settlement controller controls the camera to collect the second facial feature of the user at the payment door or closest to the payment door. Then, the settlement controller interacts with the entrance controller and determines, based on the collected second facial feature and the correspondence stored in the entrance controller, the account identifier stored in the entrance controller corresponding to the first facial feature that matches the second facial feature. The matched account identifier is used for settlement. When the user passes through the payment door with coffee, the RFID reader on the payment door can identify an RFID tag on a coffee cup, determine a type and a price of the coffee purchased by the user, and send the type and the price to the settlement controller, and the settlement controller performs settlement by using the determined account identifier. In addition, the payment door can also include a built-in bill printing apparatus. After the settlement controller completes settlement, the bill printing apparatus prints a bill so that the user can receive the bill.

It can be seen that the user only needs to directly pass through the payment door with the purchased coffee without operating the mobile phone or using a bank card for settlement. Therefore, the user does not perform additional operations, neither be the user disturbed by the settlement device.

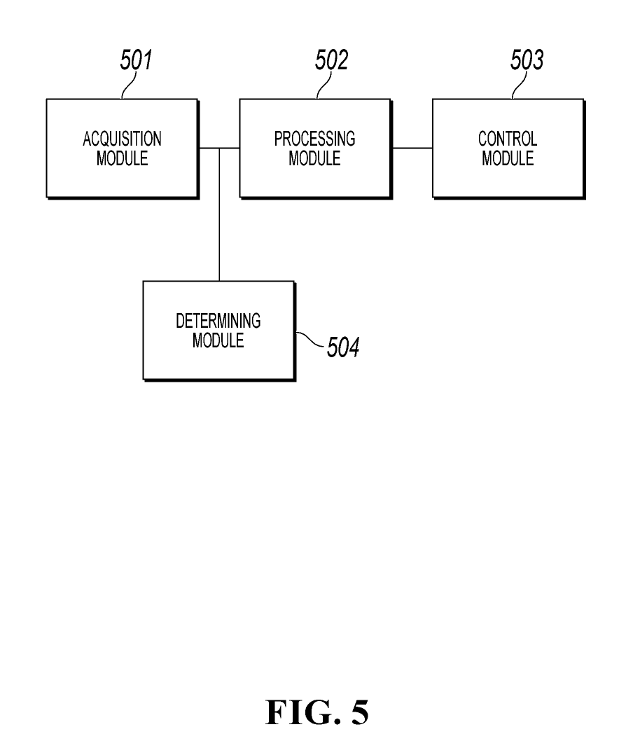

FIG. 5 shows an entrance control apparatus according to an embodiment of the present application. The entrance control apparatus includes: an acquisition module 501, configured to obtain a first biometric feature and an account identifier of a user; a processing module 502, configured to establish a correspondence between the first biometric feature and the account identifier; and a control module 503, configured to control an entrance to be open.

The first biometric feature specifically includes a first facial feature.

In the acquisition module 501, the entrance device collects the first biometric feature of the user by using a camera.

The acquisition module 501 receives the account identifier of the user, and the account identifier is sent after the user scans a two-dimensional code by using a terminal.

The apparatus further includes a determining module 504, configured to: before the processing module establishes the correspondence between the first biometric feature and the account identifier, determine that the first biometric feature is valid.

The determining module 504 searches for a third biometric feature associated with the account identifier; and if the first biometric feature matches the third biometric feature, determines that the first biometric feature is valid; or if the first biometric feature does not match the third biometric feature, determines that the first biometric feature is invalid.

The determining module 504 searches for, by using a third-party server, the third biometric feature associated with the account identifier.

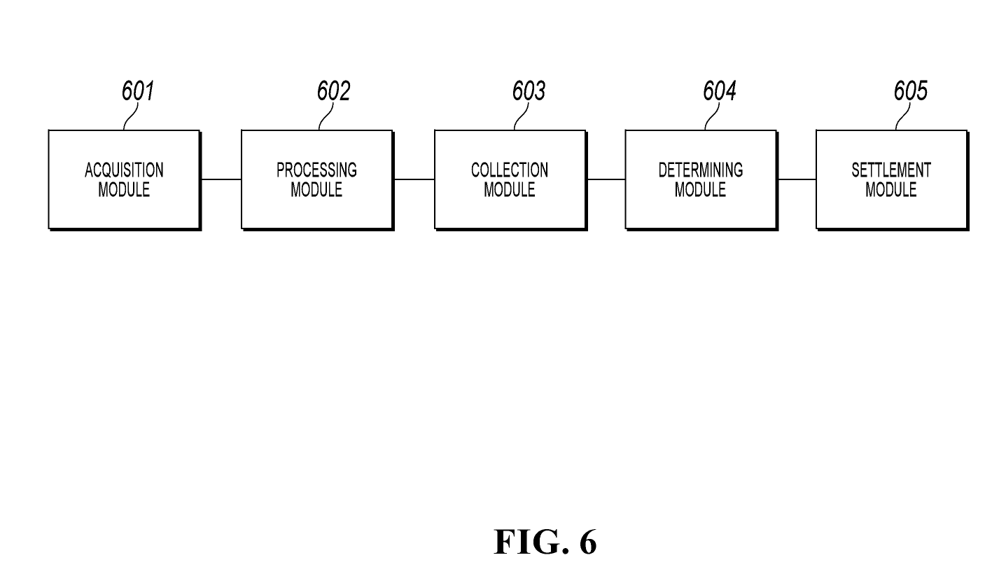

Based on the settlement method shown in FIG. 1, an embodiment of the present application further provides a corresponding settlement apparatus. As shown in FIG. 6, the settlement apparatus includes: an acquisition module 601, configured to obtain a first biometric feature and an account identifier of a user; a processing module 602, configured to: establish a correspondence between the first biometric feature and the account identifier, and store the first biometric feature, the account identifier, and the correspondence in a storage device; a collection module 603, configured to collect a second biometric feature of the user; a determining module 604, configured to determine the account identifier that is stored in the storage device and that corresponds to the first biometric feature that matches the second biometric feature; and a settlement module 605, configured to perform settlement by using the determined account identifier.

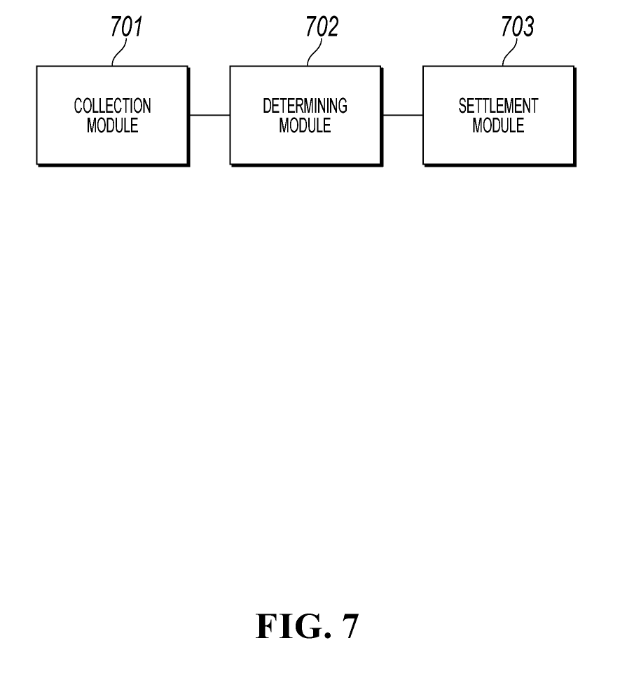

Based on the settlement method shown in FIG. 4, an embodiment of the present application further provides a corresponding settlement apparatus. As shown in FIG. 7, the settlement apparatus includes: a collection module 701, configured to collect a second biometric feature of a user; a determining module 702, configured to determine, based on a pre-stored first biometric feature, a pre-stored account identifier, and a pre-stored correspondence between the first biometric feature and the account identifier, the account identifier corresponding to the first biometric feature that matches the second biometric feature; and a settlement module 703, configured to perform settlement by using the determined account identifier.

The settlement module 703 identifies a product carried by the user, and performs, by using an account corresponding to the determined account identifier, settlement on the product carried by the user.

The product includes a radio frequency identification (RFID) tag, and the settlement module 703 includes an RFID reader.

The settlement module 703 reads product information in an RFID tag in a settlement area by using the RFID reader, where the product information includes a product price, and the RFID tag in the settlement area is the RFID tag attached to the product carried by the user in the settlement area; pays the settlement amount by using the account corresponding to the determined account identifier; and performs settlement based on the settlement amount by using the account corresponding to the determined account identifier.

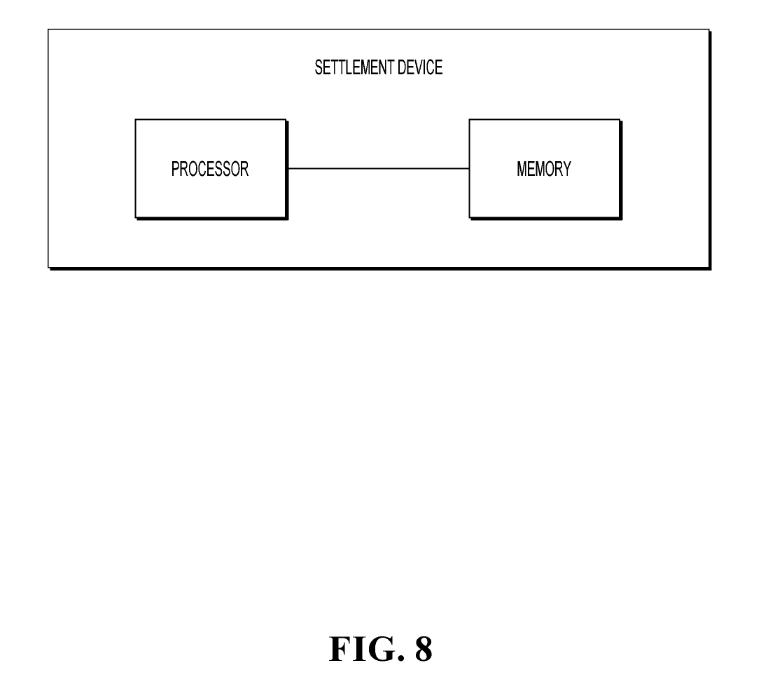

Based on the settlement method shown in FIG. 1, an embodiment of the present application provides a corresponding settlement device, as shown in FIG. 8. The settlement device includes one or more processors and a memory. The memory stores a program, and the program is configured to be used by the one or more processors to perform the following steps: obtaining a first biometric feature and an account identifier of a user; establishing a correspondence between the first biometric feature and the account identifier; collecting a second biometric feature of the user; determining the account identifier corresponding to the first biometric feature that matches the second biometric feature; and performing settlement by using the determined account identifier.

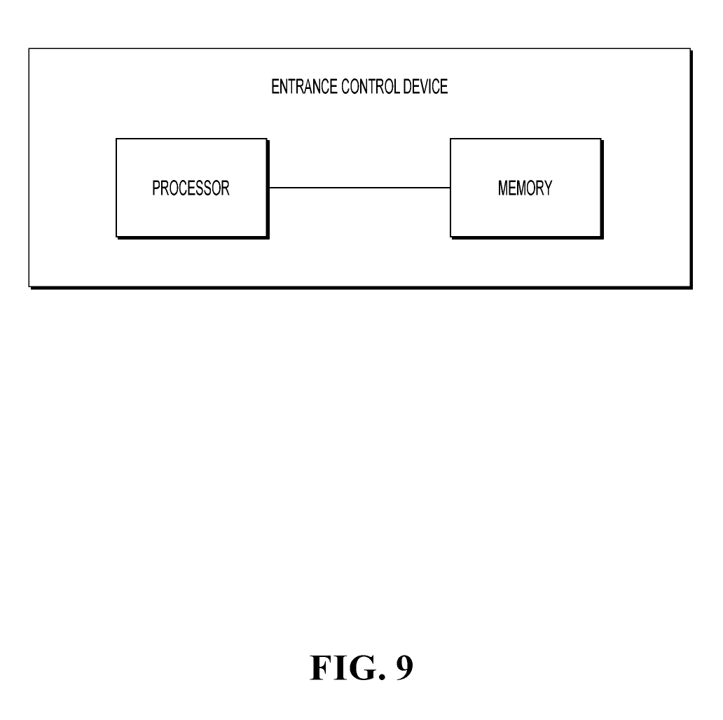

Based on the user management method shown in FIG. 3, an embodiment of the present application provides a corresponding entrance control device, as shown in FIG. 9. The user management device includes one or more processors and a memory. The memory stores a program, and the program is configured to be used by the one or more processors to perform the following steps: obtaining, by an entrance device, a first biometric feature and an account identifier of a user; establishing a correspondence between the first biometric feature and the account identifier; and controlling an entrance to be open.

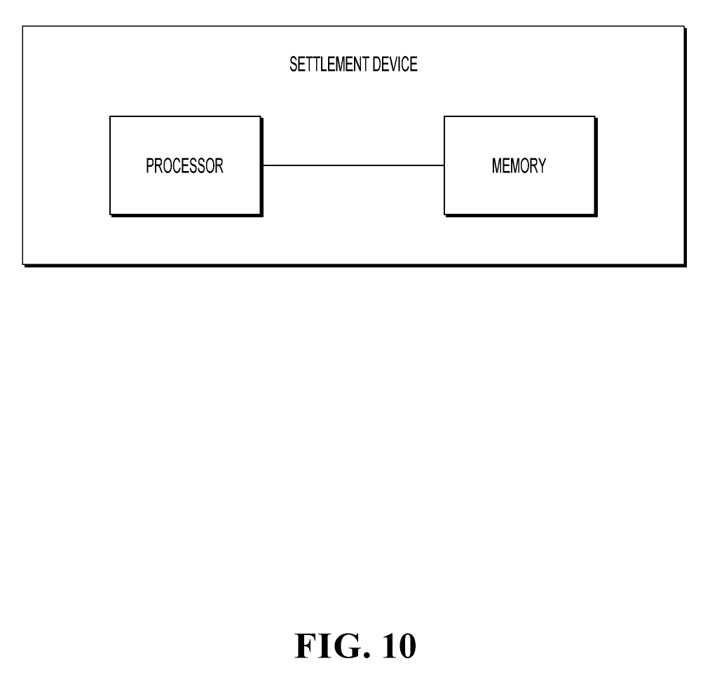

Based on the settlement method shown in FIG. 4, an embodiment of the present application provides a corresponding settlement device, as shown in FIG. 10. The settlement device includes one or more processors and a memory. The memory stores a program, and the program is configured to be used by the one or more processors to perform the following steps: collecting, by the settlement device, a second biometric feature of a user; determining, based on a pre-stored first biometric feature, a pre-stored account identifier, and a pre-stored correspondence between the first biometric feature and the account identifier, the account identifier corresponding to the first biometric feature that matches the second biometric feature; and performing settlement by using the determined account identifier.

The embodiments in this specification are all described in a progressive manner, for same or similar parts in the embodiments, reference can be made to these embodiments, and each embodiment focuses on a difference from other embodiments. Especially, the devices shown in FIG. 8 to FIG. 10 are basically similar to method embodiments, and therefore are described briefly; for related parts, reference can be made to some descriptions in the method embodiments.

In the 1990s, it can be apparently identified whether a technology is improved in terms of hardware (for example, a circuit structure of a diode, a transistor, or a switch is improved) or is improved in terms of software (a method process is improved). However, with the development of technology, the current improvement for many method processes can be considered as a direct improvement to a hardware circuit structure. Almost all design personnel program an improved method process into a hardware circuit to obtain a corresponding hardware circuit structure. Therefore, it cannot be considered that a method process cannot be improved by using a hardware module. For example, a programmable logic device (PLD) (such as a field programmable gate array (FPGA)) is such an integrated circuit, and a logical function of the programmable logic device is determined by a user by means of device programming. Design personnel “integrate” a digital system into a single PLD by means of programming without requiring a chip manufacturer to design and produce a dedicated integrated circuit chip. In addition, currently, instead of manually producing integrated circuit chips, the programming is mostly implemented by “logic compiler” software, which is similar to a software compiler used for program development and writing. Original code is also written by using a specific programming language, which is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The Very-High-Speed Integrated Circuit Hardware Description Language (VHDL) and Verilog are most commonly used currently. A person skilled in the art should also understand that a hardware circuit of a logical method process can be readily implemented once the method process is logically programmed by using the described hardware description languages and is programmed into an integrated circuit.

A controller can be implemented in any suitable way. For example, the controller can be implemented by a microprocessor, a processor, or a computer readable medium, a logic gate, a switch, an application-specific integrated circuit (ASIC), a programmable logic controller, or an embedded microcontroller for storing computer readable program code that can be executed by a microprocessor or a processor. The controller includes but is not limited to ARC 625D, Atmel AT91SAM, Microchip PIC18F26K20, and Silicon Labs C8051F320. A memory controller can be implemented as a part of control logic of a memory. A person skilled in the art also knows that, in addition to the computer readable program code, the controller can achieve the same function in a form of a logic gate, a switch, a dedicated integrated circuit, a programmable logic controller, an embedded microcontroller, etc. by logically programming the method process. Therefore, the controller can be considered as a hardware component, and apparatuses included in the controller that are used for implementing various functions can also be considered as structures in the hardware component, or apparatuses used for implementing various functions can be considered as software modules for method implementation and structures in the hardware component.

The system, apparatus, module, or unit described in the described embodiments can be specifically implemented by a computer chip, an entity, or a product that has a function. A typical implementation device is a computer. Specifically, the computer can be, for example, a personal computer, a laptop computer, a cellular phone, a camera phone, an intelligent phone, a personal digital assistant, a media player, a navigation device, an email device, a game console, a tablet computer, a wearable device, or a combination thereof

For ease of description, the described apparatus is described by dividing the apparatus into various units based on functions. Certainly, functions of each unit can be implemented in one or more pieces of software and/or hardware during implementation of the present application.

A person skilled in the art should understand that the embodiments of the present disclosure can be provided as a method, a system, or a computer program product. Therefore, the present disclosure can use a form of hardware only embodiments, software only embodiments, or embodiments with a combination of software and hardware. Moreover, the present disclosure can use a form of a computer program product that is implemented on one or more computer-usable storage media (including but not limited to a disk memory, a CD-ROM, an optical memory, etc.) that include computer-usable program code.

The present disclosure is described with reference to the flowcharts and/or block diagrams of the method, the device (system), and the computer program product according to the embodiments of the present disclosure. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer readable memory that can instruct the computer or the another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded to the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory can include a non-persistent memory, a random access memory (RAM), a non-volatile memory, and/or another form in a computer readable medium, for example, a read-only memory (ROM) or a flash memory. The memory is an example of the computer readable medium.

The computer readable medium includes persistent, non-persistent, movable, and unmovable media that can store information by using any method or technology. The information can be a computer readable instruction, a data structure, a program module, or other data. A computer storage medium includes but is not limited to a parameter random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or other optical storage, a cassette magnetic tape, tape and disk storage or another magnetic storage device or any other non-transmission media that can be configured to store information that a computing device can access. As described in this specification, the computer readable medium does not include transitory computer readable media, such as a modulated data signal and a carrier.

It should be further noted that, the terms “include”, “contain”, and any other variant thereof are intended to cover the non-exclusive inclusion, so that a process, a method, an article, or a device that includes a list of elements not only includes those elements but also includes other elements which are not expressly listed, or further includes elements inherent to such a process, method, article, or device. An element preceded by “includes a . . . ” does not, without more constraints, preclude the existence of additional identical elements in the process, method, article, or device that includes the element.

A person skilled in the art should understand that the embodiments of the present application can be provided as a method, a system, or a computer program product. Therefore, the present application can use a form of hardware only embodiments, software only embodiments, or embodiments with a combination of software and hardware. Moreover, the present application can use a form of a computer program product that is implemented on one or more computer-usable storage media (including but not limited to a disk memory, a CD-ROM, an optical memory, etc.) that include computer-usable program code.

The present application can be described in the general context of computer executable instructions executed by a computer, for example, a program module. Generally, the program module includes a routine, a program, an object, a component, a data structure, etc. for executing a particular task or implementing a particular abstract data type. The present application can also be practiced in distributed computing environments in which tasks are performed by remote processing devices that are connected by using a communications network. In the distributed computing environment, the program module can be located in both local and remote computer storage media including storage devices.

The previous descriptions are merely embodiments of the present application, and are not intended to limit the present application. For a person skilled in the art, the present application can have various modifications and changes. Any modification, equivalent replacement, or improvement made without departing from the spirit and the principle of the present application shall fall within the scope of the claims of the present application.

The specific embodiments of this subject have been described above. Other embodiments fall within the scope of the appended claims. In some cases, the actions recorded in the claims can be performed in a different order and the desired results can still be achieved. In addition, the process depicted in the accompanying drawings does not necessarily require a particular order to achieve the desired results. In some implementations, multitask processing and parallel processing can be advantageous.

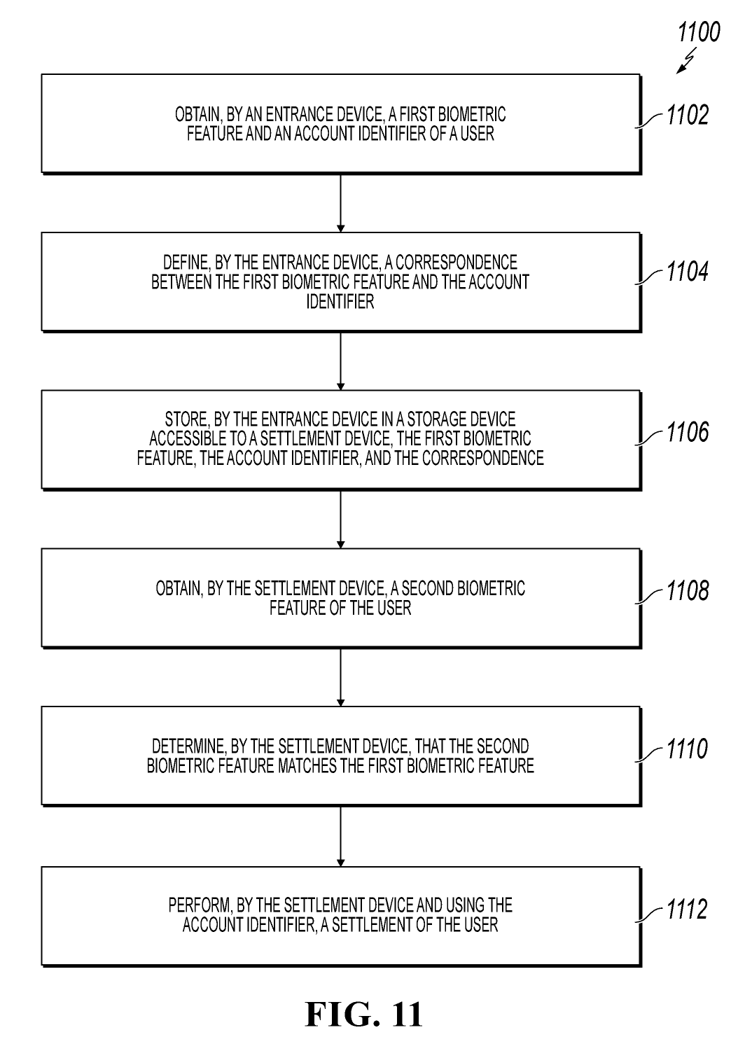

FIG. 11 is a flowchart illustrating an example of a computer-implemented method 1100 for performing a settlement, according to an implementation of the present disclosure. For clarity of presentation, the description that follows generally describes method 1100 in the context of the other figures in this description. However, it will be understood that method 1100 can be performed, for example, by any system, environment, software, and hardware, or a combination of systems, environments, software, and hardware, as appropriate. In some implementations, various steps of method 1100 can be run in parallel, in combination, in loops, or in any order.

At 1102, a first biometric feature and an account identifier of a user are obtained by an entrance device. For example, referring to FIG. 3, when the user passes through the entrance device, the acquisition module 501 can capture a first facial feature, such as an image of the user's face. The first facial feature can be captured, for example, using a camera that is communicatively coupled with the entrance device. Other biometric features of the user that can be used instead of, or in addition to, facial features include, include for example, a finger or thumb print, a retinal scan, or a voice recording. In some implementations, the entrance device that obtains the first biometric feature and the account identifier can be part of the settlement system of FIG. that also includes the storage module and the settlement device.

In some implementations, obtaining the account identifier of the user can include receiving, from a terminal, a two-dimensional code obtained using a scanner at the terminal, and receiving, by the entrance device and using the two-dimensional code, the account identifier of the user. For example, a scanner at the entrance device can capture a two-dimensional code, such as a quick response (QR) code, a bar code, or some other machine-readable code that is present on, and can be scanned from, an object carried or worn by the user. In some implementations, the account identifier can be an account number, a user name, an email address, a phone number, or some other identifier that uniquely identifies the user.

In some implementations, a card or other object can be scanned that includes, or can be used to obtain, the account identifier of the user. In some implementations, when the two-dimensional code is read, other actions unrelated to settlements can be performed. For example, upon a successful scan of a two-dimensional code by the user, a turnstile, door, or gate can open. The turnstile, for example, can be part of, or communicatively coupled with, the entrance device. From 1102, method 1100 proceeds to 1104.

At 1104, a correspondence between the first biometric feature and the account identifier is defined by the entrance device. As an example, the processing module 502 can establish the correspondence between the first biometric feature and the account identifier.

In some implementations, method 1100 can further include determining that the first biometric feature is valid. Validity can indicate, for example, that the first biometric feature uniquely identifies the user or has a quality that can unique define or identify the user. In some implementations, determining that the first biometric feature is valid can occur, for example, before the correspondence between the first biometric feature and the account identifier is defined.

In some implementations, determining whether the first biometric feature is valid can include searching for a third biometric feature associated with the account identifier. The third biometric feature can be a stored biometric feature that was obtained from (or provided by) the user at a previous time, such as during registration or initialization of the account by the user. When a determination is made that the first biometric feature matches the third biometric feature, then the first biometric feature can be determined to be valid. When a determination is made that the first biometric feature does not match the third biometric feature, then the first biometric feature can be determined to be invalid. From 1104, method 1100 proceeds to 1106.

At 1106, the first biometric feature, the account identifier, and the correspondence are stored by the entrance device in a storage device accessible to a settlement device. The entrance device of FIG. 3, for example, can store the account identifier and the correspondence in a data base, data table, or other data store that is accessible to the settlement device of FIG. 4. From 1106, method 1100 proceeds to 1108.

At 1108, a second biometric feature of the user is obtained by the settlement device. As an example, the collection module 603 can collect the second biometric feature of the user. The second biometric feature can also be a facial feature, such as an image of the user's face captured by a camera in a vicinity of the settlement device. Generally, the type of second biometric feature can match the same type of biometric feature that is obtained at 1102. From 1108, method 1100 proceeds to 1110.

At 1110, a determination is made by the settlement device that the second biometric feature matches the first biometric feature. For example, the determining module 604 can determine that the account identifier that is stored in the storage device (that corresponds to the first biometric feature) matches the second biometric feature. If the first and second biometric features are facial features, for example, then the determining module 604 can perform an image comparison. In some implementations, image comparison can include comparing predetermined points on the user's face, such as the user's cheeks, nose, chin, eyes, and ears. In some implementations, the determining module 604 can perform image transformation, such as if the cameras used to obtain the images are not situated to capture images from the same angle. From 1110, method 1100 proceeds to 1112.

At 1112, a settlement of the user is performed by the settlement device using the account identifier. As an example, the settlement module 605 can perform settlement by using the determined account identifier corresponding to the user.

In some implementations, performing the settlement can include identifying a product carried by the user and performing, using an account corresponding to the account identifier, the settlement on the product carried by the user. Settlement can include, for example, a purchase of the product, a rental of the product, registration of the product, or some other product-related action.

In some implementations, the product can include a radio frequency identification (RFID) tag, and the settlement device can include an RFID reader. Identifying the product carried by the user can include, for example, reading product information in the RFID tag using the RFID reader. The product information can include, for example, a name of the product, a product price, a product description, product dimensions, and a product weight. Performing the settlement (for example, a purchase or a rental) can include calculating a settlement amount for the product that is based on the product price. The settlement amount can also be based on a quantity or size of the product, for example, a quantity of the product being purchased.

In some implementations, the product can be a cup of coffee (as described with respect to FIG. 4) or some other food or beverage product. In this example, an RFID tag can be attached on or embedded within the coffee cup. After 1112, method 1100 stops.

The present disclosure describes techniques for improving a settlement process. For example, by capturing and comparing biometric features of the user at the entrance device and the settlement device, automatic authentication of the user can be performed. In this way, the user need not obtain a ticket or other receipt for a product being purchased. By automatically scanning a product for which the settlement is to occur, the user does not need to employ applications on a mobile device in order to identify the product. The use of the barometric features and a scan of the product can help to speed up transactions. Comparison of the biometric features, for example, can only feasibly be performed by a computer, which is important if many users (for example, customers) are performing settlements (for example, purchases) at a same brick-and-mortar location.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
obtaining, by the settlement device, a biometric feature of the user;
determining, by the settlement device, that the obtained biometric feature matches a stored biometric feature, wherein the stored biometric feature corresponds to an account identifier; and
in response to determining that the obtained biometric feature matches the stored biometric feature, performing, by the settlement device, a settlement of an account associated with the account identifier that corresponds to the stored biometric feature.

2. The computer-implemented method of claim 1, further comprising:
before obtaining the biometric feature of the user:
obtaining, by an entrance device, a first biometric feature and an account identifier of a user;
defining, by the entrance device, a correspondence between the first biometric feature and the account identifier; and
storing, by the entrance device in a storage device accessible to the settlement device, the first biometric feature, the account identifier, and the correspondence, wherein the first biometric feature is the stored biometric feature.

3. The computer-implemented method of claim 2, wherein the first biometric feature comprises a first facial feature, and wherein obtaining the first biometric feature of the user comprises collecting, by the entrance device, the first biometric feature of the user by using a camera.

4. The method of claim 2, wherein obtaining the account identifier of the user comprises:
receiving, from a terminal, a two-dimensional code obtained using a scanner at the terminal; and
receiving, by the entrance device and using the two-dimensional code, the account identifier of the user.

5. The method of claim 2, further comprising determining that the first biometric feature is valid, the determining occurring before defining the correspondence between the first biometric feature and the account identifier.

6. The method of claim 5, wherein determining whether the first biometric feature is valid comprises:
searching for a third biometric feature associated with the account identifier; and
when a determination is made that the first biometric feature matches the third biometric feature, determining that the first biometric feature is valid; and
when a determination is made that the first biometric feature does not match the third biometric feature, determining that the first biometric feature is invalid.

7. The method of claim 1, wherein the performing the settlement comprises:
identifying a product carried by the user; and
performing, using an account corresponding to the account identifier, the settlement on the product carried by the user.

8. The method of claim 7, wherein the product includes a radio frequency identification (RFID) tag, wherein the settlement device includes an RFID reader, wherein identifying the product carried by the user comprises reading, using the RFID reader, product information in the RFID tag, the product information including a product price, and wherein performing the settlement comprises:
calculating, based on the product price, a settlement amount corresponding to the product; and
performing the settlement using the settlement amount.

9. A non-transitory, computer-readable medium storing one or more instructions executable by a computer system to perform operations comprising:
obtaining, by the settlement device, a biometric feature of the user;
determining, by the settlement device, that the obtained biometric feature matches a stored biometric feature, wherein the stored biometric feature corresponds to an account identifier; and
in response to determining that the obtained biometric feature matches the stored biometric feature, performing, by the settlement device, a settlement of an account associated with the account identifier that corresponds to the stored biometric feature.

10. The non-transitory, computer-readable medium of claim 9, the operations further comprising:
before obtaining the biometric feature of the user:
obtaining, by an entrance device, a first biometric feature and an account identifier of a user;
defining, by the entrance device, a correspondence between the first biometric feature and the account identifier; and
storing, by the entrance device in a storage device accessible to the settlement device, the first biometric feature, the account identifier, and the correspondence, wherein the first biometric feature is the stored biometric feature.

11. The non-transitory, computer-readable medium of claim 10, wherein the first biometric feature comprises a first facial feature, and wherein obtaining the first biometric feature of the user comprises collecting, by the entrance device, the first biometric feature of the user by using a camera.

12. The non-transitory, computer-readable medium of claim 10, wherein obtaining the account identifier of the user comprises:
receiving, from a terminal, a two-dimensional code obtained using a scanner at the terminal; and
receiving, by the entrance device and using the two-dimensional code, the account identifier of the user.

13. The non-transitory, computer-readable medium of claim 10, the operations further comprising determining that the first biometric feature is valid, the determining occurring before defining the correspondence between the first biometric feature and the account identifier.

14. The non-transitory, computer-readable medium of claim 13, wherein determining whether the first biometric feature is valid comprises:
searching for a third biometric feature associated with the account identifier; and
when a determination is made that the first biometric feature matches the third biometric feature, determining that the first biometric feature is valid; and
when a determination is made that the first biometric feature does not match the third biometric feature, determining that the first biometric feature is invalid.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining, by the settlement device, a biometric feature of the user;
determining, by the settlement device, that the obtained biometric feature matches a stored biometric feature, wherein the stored biometric feature corresponds to an account identifier; and
in response to determining that the obtained biometric feature matches the stored biometric feature, performing, by the settlement device, a settlement of an account associated with the account identifier that corresponds to the stored biometric feature.

16. The computer-implemented system of claim 15, the operations further comprising:
before obtaining the biometric feature of the user:
obtaining, by an entrance device, a first biometric feature and an account identifier of a user;
defining, by the entrance device, a correspondence between the first biometric feature and the account identifier; and
storing, by the entrance device in a storage device accessible to the settlement device, the first biometric feature, the account identifier, and the correspondence, wherein the first biometric feature is the stored biometric feature.

17. The computer-implemented system of claim 16, wherein the first biometric feature comprises a first facial feature, and wherein obtaining the first biometric feature of the user comprises collecting, by the entrance device, the first biometric feature of the user by using a camera.

18. The computer-implemented system of claim 16, wherein obtaining the account identifier of the user comprises:
receiving, from a terminal, a two-dimensional code obtained using a scanner at the terminal; and
receiving, by the entrance device and using the two-dimensional code, the account identifier of the user.

19. The computer-implemented system of claim 16, the operations further comprising determining that the first biometric feature is valid, the determining occurring before defining the correspondence between the first biometric feature and the account identifier.

20. The computer-implemented system of claim 19, wherein determining whether the first biometric feature is valid comprises:
searching for a third biometric feature associated with the account identifier; and
when a determination is made that the first biometric feature matches the third biometric feature, determining that the first biometric feature is valid; and
when a determination is made that the first biometric feature does not match the third biometric feature, determining that the first biometric feature is invalid.
